(19) United States
(12) Patent Application Publication
(10) Pub. No.: US 2002/0133361 A1
(43) Pub. Date: Sep. 19, 2002

(54) Secure item sending/receiving business method

(76) Inventors: Gary J. Kindell, Port St. Lucie, FL (US); Thomas G. Spear, Vero Beach, FL (US)

Correspondence Address: Edward M. Livingston, Esq., 628 Ellen Dr., P.O. Box 1599, Winter Park, FL, 32790, US

(21) Appl. No.: 09/804,844

(22) Filed: Mar. 13, 2001

(51) Int. Cl. G06F 17/60

(52) U.S. Cl. 705/1

(57) ABSTRACT

A business method for secure sending and receiving of items (2) to and from secure enclosures 4 has method steps that include: providing a secure item sending/receiving business system with a control unit (1) for coordinating, regulating and recording for the secure item sending/receiving business system; providing a single-use-access code (6) for single-use access to a secure enclosure (4); and qualifying pickup and delivery accessibleness by enabled item handlers (5) and by independent item handlers (9) to the secure enclosures.

### BACKGROUND OF THE INVENTION

This invention relates to a business method for sending and receiving of items securely to a secure enclosure at the point of delivery or sending.

Receiving delivery of and sending of items to and from a remote destination is surging rapidly with use of the Internet, telephones and other communications. There are prominent contributing factors to this surge of remote-order business. Facilitation of decision making for ordering by the Internet, by catalogues and by direct marketing generally is increasing. Convenience of pickup and delivery services is increasing with a proliferation of commercial pickup and deliver services in addition to privatization of the U.S. Postal Service. An item recipient/sender may not be present when a delivery or a pickup is made at growing numbers of homes, businesses and various other sites. Traveling, eating out, education, working parents, increased shopping with increased disposable income, increasing involvement in use of time and other engaging factors increase probability that the item recipient/sender may not be present, whether intentionally or inadvertently, to receive or send items.

Deliveries are often attempted several times or delivered items are frequently stolen when left unprotected at a receiving or sending site. Highly inconvenient and onerous also, an item recipient/sender may be forced to choose between being present and making some alternative arrangements, to send or to receive items.

There are known secure containers and rooms such as described in U.S. Pat. No. 5,979,750 granted to Kindell on Nov. 9, 1999 and in U.S. Pat. No. 5,774,053 granted to Porter on Jun. 30, 1998. However, there is no known coherent and coordinated business method for sending and receiving of items securely and conveniently in a manner taught by this invention.

### SUMMARY OF THE INVENTION

Objects of patentable novelty and utility taught by this invention are to provide a business method for sending and receiving of items which:

describes a business system to coordinate secure sending and receiving of items sent by a remote item sender;

utilizes single-use-access coding for secure and limited accessing of sending and receiving facilities;

allows customers to receive remotely sent items safely, conveniently and without being present or without being bothered by delivery;

allows customers to receive remotely sent items safely without being aware that the item is being sent;

allows vendors and other senders to deliver items securely during any designated time frame;

allows deliverers of items to deliver such items securely during any designated time frame;

allows items to be delivered to a secure enclosure without the remote senders prior knowledge of existence of the secure enclosure;

allows convenient pickup of items during any designated time frame for being shipped, mailed or otherwise sent; and

provides account records of past, present, and future ordering, sending and receiving of items to and from secure enclosures.

This invention accomplishes these and other objectives with a business method for sending and receiving of items having method steps that include: establishing an item sending/receiving-control business; providing single-use-access coding for single-use access to a receiving site; recording orders for pickup and delivery at secure sites; qualifying pickup and delivery accessibleness to the secure sites; and recording the information associated with the pickup and delivery of the items at the secure site.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a schematic outline of the business method for owners of secure enclosures to receive items from remote item senders utilizing enabled item handlers;

FIG. 2 is a schematic outline of the business method for owners of secure enclosures to order pickup of items to be sent by enabled item handlers; and

FIG. 3 is a schematic outline of the business method for owners of secure enclosures to order pickup or delivery of items by independent item handlers.

### DESCRIPTION OF PREFERRED EMBODIMENT

Listed numerically below with reference to the drawings are terms used to describe features of this invention. These terms and numbers assigned to them designate the same features throughout this description.

1. Control unit

2. Item

3. Owner

4. Secure enclosure

5. Enabled item handler

6. Single-use access code

8. Remote item sender

9. Independent item handler

10. Inform

11. Pickup order

12. Pickup

13. Pickup-or-delivery order

14. Pickup or delivery

15. Contact direction

16. Owner's identification indicia

17. handler's identification indicia

18. Owner identification

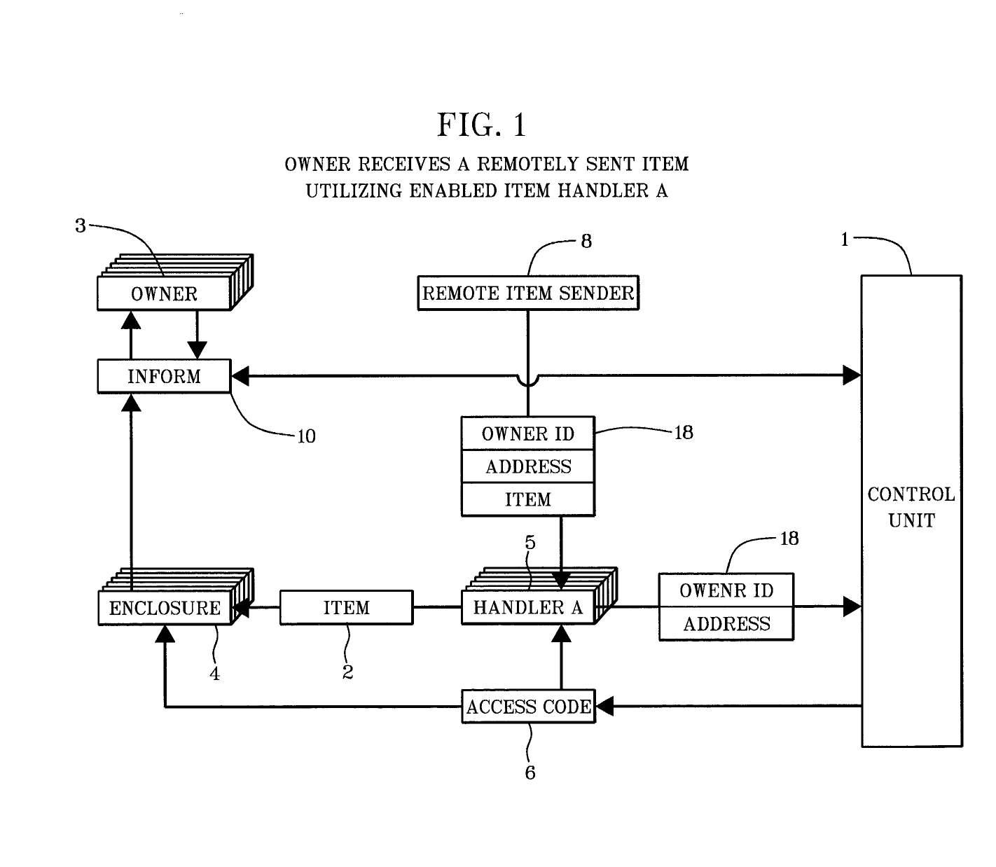

Referring first to FIG. 1, an item sending/receiving business method has steps that comprise providing an item sending/receiving business system with a control unit 1 which coordinate secure pickup, deliver, recording, handling and transporting of items 2 for owner 3 of a secure enclosure 4 from which the items 2 are taken out for pickup or into which the items 2 are placed for delivery by an enabled item handler 5 having a single-use access code 6 provided by the control unit.

A plurality of secure enclosures 4 are provided for a network of owners 3 of the secure enclosures 4 for receiving delivery of items 2 sent remotely and for sending items 2 as ordered remotely for pickup in accordance with the item sending/receiving business system. The secure enclosures 4 can include the secure containers and rooms described in U.S. Pat. No. 5,979,750 granted to Kindell on Nov. 9, 1999 and incorporated herein by reference. Included also is any secure enclosure 4, plurality of secure enclosures 4 or class of secure enclosures 4 which can be accessed by or be made accessible by the single-use access code 6 in accordance with a single-use access-coding system employed in accordance with this item sending/receiving business method. For homes and home businesses, the secure enclosure 4 is preferably a container either outside of inside of, or a part of a residence and accessible by the enabled handler 5 preferably without entry into the residence. For business, institutional and other organizational entities that are separate from a residence, the secure enclosure 4 can include up to entire shipping-and-receiving structures with optional loading docks for accommodating load-to-letter sizes of items 2. Numerically, however, a large portion of the items 2 are parcels that can be accommodated by secure enclosures 4 that are box-sized secure containers.

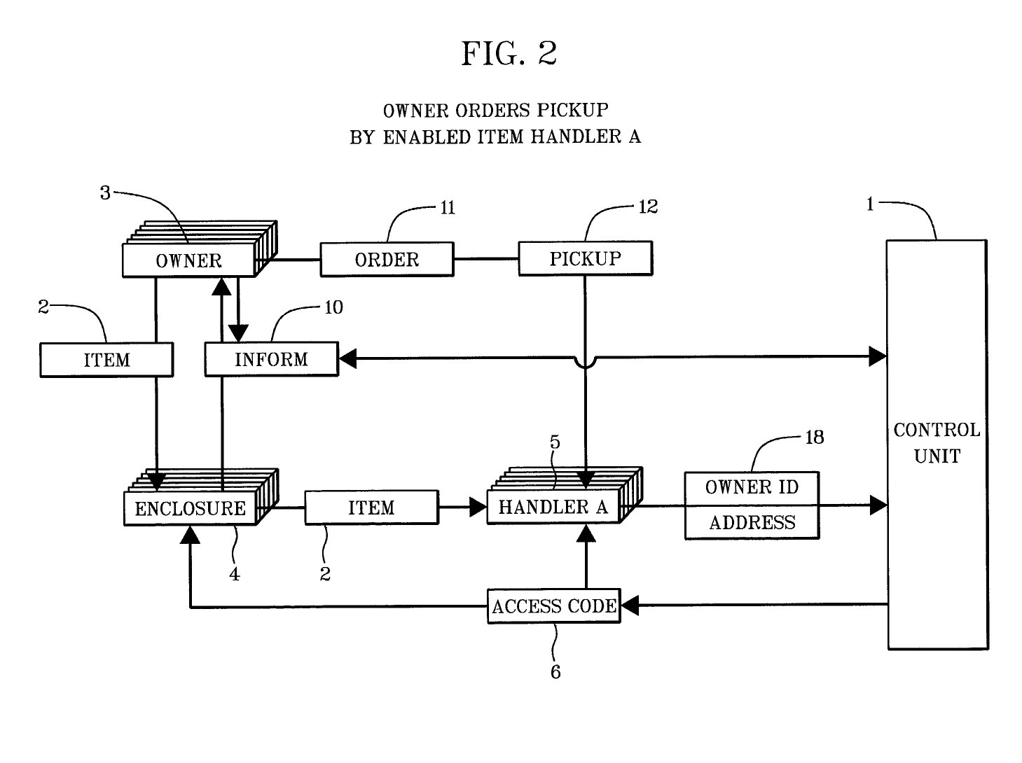

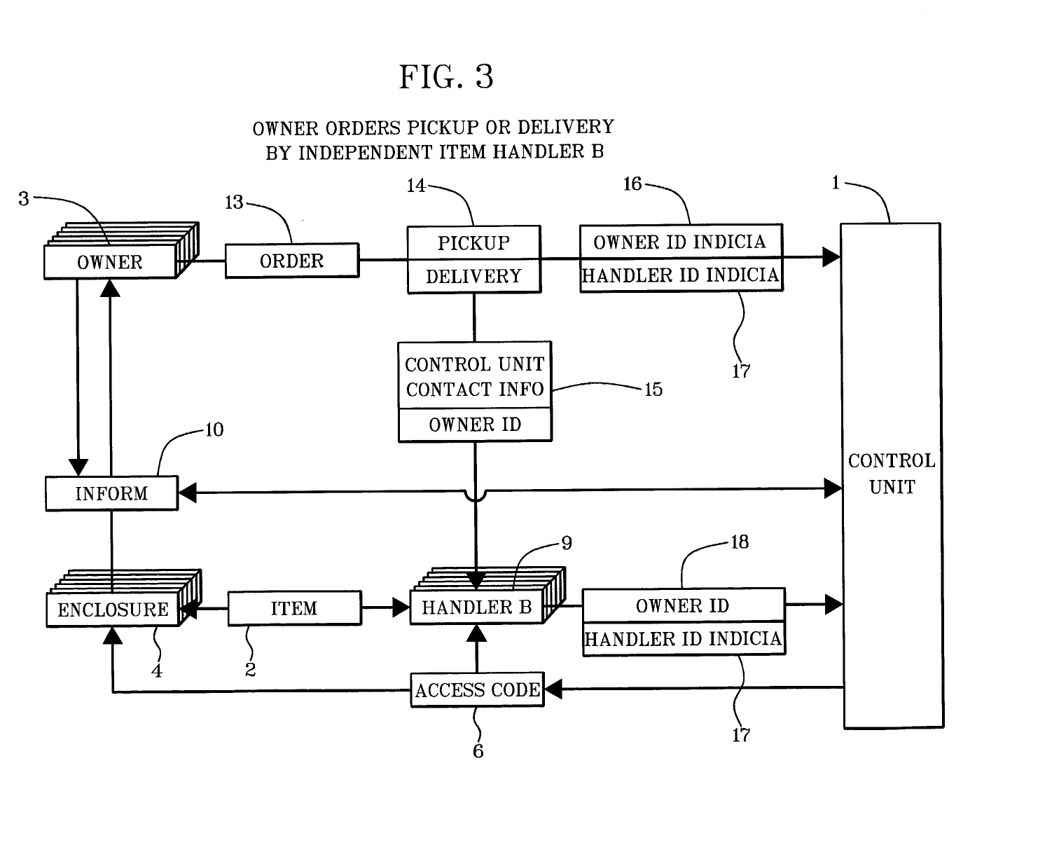

This item sending/receiving business method includes security that is coordinated by the control unit 1 for pickup and delivery. For security of items to be delivered, the method includes receiving items from remote item senders 8 that sent items utilizing an item handler which would be enabled by the control unit 1 for security as the enabled item handler 5. The enabled item handler 5, a plurality of enabled item handlers 5 shown as handler A in FIGS. 1-2 is a pre-enabled or pre-authorized item handler that is preferably employed or contracted by the control unit 1 or the remote item sender 8 in contrast to an independent item handler 9 shown in FIG. 3 as handler B that has not been pre-enabled by the control unit 1.

For either the enabled item handler 5 or the independent item handler 9, a single-use access code 6 in accordance with a single-use access coding system coordinated by the control unit 1 is provided discretionarily for security by the control unit 1 for each access to the secure enclosure 4. The single-use access code 6 is disabled after access accordingly.

Standard procedure for communication intermediate and for activities by the owners, the control unit, item sender, secure enclosures 4, item handlers and affected other parties is preferably provided by and is coordinated or otherwise administered by the control unit 1 in accordance with this item sending/receiving business system. The control unit 1 can be either a separate entity or totally or partially a part of either the enabled item handler 5, the remote item sender 8 or the independent item handler 9 or the secure enclosure 4. Also, portions of activities of the control unit 1 can be accomplished by the enabled item handler 5, the remote item sender 8 and the independent item handler 9 or the secure enclosure 4. Steps of this business system are controllably and functionally separable and divisible.

In a FIG. 1 embodiment of this business method, an owner 3 that is one of the owners of a secure enclosure 4 is to receive an item 2 from the remote item sender 8 utilizing the enabled item handler 5 for delivery of the item 2 to the secure enclosure 4 at either a personal, business, or other such address of the owner 3 in accordance with the item sending/receiving business system and comprising the following steps:

the remote item sender 8 conveying the item 2 to the enabled item handler 5 for shipment of the item;

the enabled item handler 5 predeterminedly communicating the owner identification 18 (possibly the address of the secure enclosure 4) to the control unit 1;

the control unit 1 identifying and qualifying the owner 3 as an owner 3 of the secure enclosure 4;

the control unit 1 providing a single-use access code 6 to the enabled item handler 5 for delivery of the item 2;

the enabled item handler 5 providing a driver/deliverer with the single-use access code 6;

the control unit 1 communicating the single-use access code 6 to the secure enclosure 4, possibly with electronic, web or telegraphic means received by a control apparatus on the secure enclosure 4, to permit access to the secure enclosure 4 by the enabled item handler 5 for delivery of the item 2;

the driver/deliverer delivering the item 2 to the secure enclosure 4;

the secure enclosure 4 communicating, possibly with the electronic, web or telegraphic means of a control apparatus on the secure enclosure 4, the access to the secure enclosure 4 in accordance with the single-use access code 6;

the single-use access code 6 being disabled accordingly;

the control unit 1 informing the owner 3 of the delivery of the item 2; and

the control unit 1 maintaining records of the item 2 delivery and other related coordination and control factors predeterminedly.

Communications for this item sending/receiving business method can be intermediate people, organizational units and inanimate things that include the secure enclosure 4 with use of known communications media, control apparatuses and artificial intelligence. Prior limitations of communication between people and objects have been diminished accordingly. In FIGS. 1-3, communication of information is shown as inform 10 separately from communication in combination with action.

In a FIG. 2 embodiment of this business method, the owner 3 orders a pickup 12 of the item 2 by the enabled item handler 5 for delivery of the item 2 to a designated party affected by the business method at an address designated by the owner 3 in accordance with the item sending/receiving business system and comprising the steps of:

the owner 3 communicating with the enabled item handler 5 which can include a parcel-handling or delivery-service entity, through any group of communications media that includes the Internet, electronic, a telephone, the mail and a messenger;

the owner 3 placing a pickup order 11 with the enabled item handler 5 for a pickup 12 of the item 2 that can include something to be sent by the owner 3;

the owner 3 providing the enabled item handler 5 with the predetermined owner identification 18 possibly the secure enclosure's address, as appropriate for an ultimate delivery of the item to the designated party;

the owner 3 placing the item 2 in the secure enclosure 4;

the enabled item handler 5 communicating with the control unit 1 and providing the control unit 1 with the owner identification 18;

the control unit 1 identifying the owner 3 as an owner of a secure enclosure 4 and qualified sender of the item 2;

the control unit 1 providing the enabled item handler 5 with a single-use access code 6 for accessing the secure enclosure 4 for pickup of the item 2;

the enabled item handler 5 providing a pickup driver/entity with the single-use access code 6;

the control unit 1 communicating the single-use access code 6 to the secure enclosure 4 with appropriate electronic communication means;

the pickup driver/entity accessing the secure enclosure 4 and picking up the item 2 therefrom;

the single-use-access code 6 being disabled accordingly;

the control unit 1 being informed by the secure enclosure 4 of the pickup 12 of the item 2;

the control unit 1 informing the owner 3 of the pickup 12 of the item 2; and

the control unit 1 maintaining records of the pickup 12 predeterminedly.

In a FIG. 3 embodiment of this business method, the owner 3 orders pickup or delivery 14 of the item 2 by the independent item handler 9 that is not enabled in accordance with the item sending/receiving business system and comprising the steps of:

the owner 3 communicating a pickup-or-delivery order 13 to the independent item handler 9;

the owner 3 providing the independent item handler 9 with predetermined contact direction 15 possibly the control unit's phone number and the secure enclosure's address, for communicating with the control unit 1 for the independent item handler 9 to obtain independent-handler authorization to execute the pickup-or-delivery order 13;

the owner 3 providing the independent item handler 9 with predetermined owner identification 18;

the owner 3 communicating the owner's identification indicia 16 and handler's identification indicia 17 possibly the owners predetermined pin and the independent handler's phone number to the control unit 1;

the independent item handler 9 communicating the independent item handler's identification indicia 17 possibly the handler's phone number and the predetermined owner identification 18 possibly the secure enclosure's address to the control unit 1;

the control unit 1 matching information received from the owner 3 with information received from the independent item handler 9 and selectively utilizing other information to allow the independent-handler authorization;

the control unit 1 providing the independent-handler authorization predeterminedly to the independent item handler 9;

the control unit 1 providing the independent item handler 9 with a single-use access code 6 for access to the secure enclosure 4 for pickup or delivery 14 of the item 2;

the control unit 1 communicating the single-use access code 6 to the secure enclosure 4;

the independent item handler 9 accessing the secure enclosure 4;

the independent item handler picking up the item 2 from the secure enclosure 4 or placing the item 2 in the secure enclosure 4 in accordance with the pickup-or-delivery order 13;

the secure enclosure 4 communicating to the control unit 1 that access thereto has been completed in accordance with the single-use access code 6;

the single-use access code 6 being disabled accordingly;

the control unit 1 communicating to the owner 3 that the access to the secure enclosure 4 has been completed in accordance with the single-use access code 6 for the pickup-or-delivery order 13; and

the control unit 1 maintaining records of the pickup or delivery 14 predeterminedly.

A new and useful item sending/receiving business method having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. An item sending/receiving business method having steps that comprise:
providing an item sending/receiving business system with a control unit which coordinates secure pickup, delivery, recording, handling and transporting of items remotely sent;
providing a plurality of secure enclosures in which owners of the secure enclosures receive delivery of items and from which the owners send items ordered remotely for pickup in accordance with the item sending/receiving business system;
enabling item handlers for accessibleness to the secure enclosures;
providing single-use-access coding for item handlers to access predetermined secure enclosures for predetermined single access that is disabled predeterminedly; and
providing standard procedure for communication intermediate and for activities by the owners, the control unit, item senders, secure enclosures, item handlers and affected other parties in accordance with the item sending/receiving business system.

2. The method of claim 1 wherein:
an owner of one of the secure enclosures is expected to receive an item from a remote item sender utilizing an enabled item handler for delivery to the secure enclosure in accordance with the item sending/receiving business system and comprising the steps of:
the remote item sender conveying the item to the enabled item handler for delivery of the item;
the enabled item handler predeterminedly communicating the owner predetermined identification to the control unit;
the control unit identifying and qualifying the owner as an owner of the secure enclosure;
the control unit providing a single-use access code to the enabled item handler for delivery of the item;
the enabled item handler providing a driver/deliverer with the single-use access code;
the control unit communicating the single-use access code to the secure enclosure to permit access to the secure enclosure by the enabled item handler for delivery of the item;
the driver/deliverer delivering the item to the secure enclosure;
the secure enclosure communicating access to the secure enclosure in accordance with the single-use access code;
the single-use access code being deleted accordingly;
the control unit informing the owner of delivery of the item; and
the control unit maintaining records of the item delivery predeterminedly.

3. The method of claim 1 wherein:
the owner orders pickup of an item by the enabled item handler for delivery of the item to a designated party at an address designated by the owner in accordance with the item sending/receiving business system and comprising the steps of:
the owner placing a pickup order with the enabled item handler for a pickup of the item;
the owner providing the enabled item handler with the owner's identification and delivery information as appropriate for an ultimate delivery of the item to the designated party;
the owner placing the item in the secure enclosure;
the enabled item handler communicating with the control unit and providing the control unit with the appropriate designated owner's identification and the delivery information;
the control unit identifying the owner as an owner of a secure enclosure and a qualified sender of the item;
the control unit providing the enabled item handler with a single-use access code for accessing the secure enclosure for pickup of the item;
the enabled item handler providing a pickup driver/entity with the single-use access code;
the control unit communicating the single-use access code to the secure enclosure;
the pickup driver/entity accessing the secure enclosure and picking up the item therefrom;
the single-use-access code being disabled accordingly;
the control unit being informed by the secure enclosure of the pickup of the item;
the control unit informing the owner of the pickup of the item; and
the control unit maintaining records of the pickup predeterminedly.

4. The method of claim 1 wherein:
the owner selectively orders pickup or delivery of an item by an independent item handler that is not enabled in accordance with the item sending/receiving business system and comprising the steps of:
the owner communicating a pickup-or-delivery order to the independent item handler;
the owner providing the independent item handler with predetermined contact direction for communicating with the control unit for the independent item handler to obtain independent-handler authorization to execute the pickup-or-delivery order;
the owner providing the independent item handler with predetermined identification of the owner;
the owner communicating the owner's predetermined identification indicia and the independent item handler's predetermined identification indicia to the control unit;
the independent item handler communicating the independent item handler's predetermined identification indicia and the predetermined identification of the owner to the control unit;
the control unit matching information received from the owner with information received from the independent item handler and selectively utilizing other information to allow the independent-handler authorization;
the control unit providing the independent-handler authorization predeterminedly to the independent item handler;
the control unit providing the independent item handler with a single-use access code for access to the secure enclosure for pickup or delivery of the item;
the control unit communicating the single-use access code to the secure enclosure;
the independent item handler accessing the secure enclosure;
the independent item handler picking up the item from the secure enclosure or placing the item in the secure enclosure in accordance with the pickup-or-delivery order;
the secure enclosure communicating to the control unit that access thereto has been completed in accordance with the single-use access code;
the single-use access code being disabled accordingly;
the control unit communicating to the owner that the access to the secure enclosure has been completed in accordance with the single-use access code for the pickup-or-delivery order; and
the control unit maintaining records of the pickup or delivery predeterminedly.

5. The method of claim 1 wherein:
communication intermediate the owner, the control unit, item handlers, remote item senders, secure enclosures and designated other parties is made on the Internet predeterminedly.

6. The method of claim 1 wherein:
the communication intermediate the owner, the control unit, item handlers, remote item senders, secure enclosures and designated other parties is made by telephone predeterminedly.

7. The method of claim 1 wherein:
the communication intermediate the owner, the control unit, item handlers, remote item senders, secure enclosures and designated other parties is made by mail predeterminedly.

8. The method of claim 1 wherein:
the communication intermediate the owner, the control unit, item handlers, remote item senders, secure enclosures and designated other parties is made person-to-person predeterminedly.

9. The method of claim 1 wherein:
communications of steps of this item sending/receiving business method are electronic predeterminedly.

10. The method of claim 9 wherein:
the communications of the steps of this item sending/receiving business method are automatic predeterminedly.

11. The method of claim 1 wherein:
predetermined activities of the control unit are performed by a predetermined item handler.

12. The method of claim 1 wherein:
predetermined activities of the control unit are performed by a predetermined remote item sender.

13. The method of claim 1 wherein:
predetermined activities of the control unit are performed by the secure enclosure.

14. The method of claim 1 wherein:
the control unit stores the memory of the single-use access codes.

15. The method of claim 1 wherein:
the secure enclosure stores the memory of the single-use access codes.

16. The method of claim 1 wherein:
the owner rejects the access prior to the delivery or pickup;
the control unit deletes the single-use access code; and
the control unit communicating rejection of the access to the item handler.

17. The method in claim 1 wherein:
the item handler is a layperson.

18. The method in claim 1 wherein:
the item handler is a merchant.

19. The method in claim 4 wherein:
the owner's predetermined identification indicia is a number.

20. The method in claim 4 wherein:
the owner's predetermined identification indicia is comprised of symbols.

21. The method in claim 4 wherein:
the owner's predetermined identification indicia is comprised of numbers and symbols selectively.

22. The method in claim 4 wherein:
the handler's predetermined identification indicia is a telephone number.

23. The method in claim 4 wherein:
the handler's predetermined identification indicia is a number.

24. The method in claim 4 wherein:
the handler's predetermined identification indicia is comprised of symbols.

25. The method in claim 4 wherein:
the handler's predetermined identification indicia is comprised of numbers and symbols selectively.

26. The method in claim 1 wherein:
the owner's predetermined identification is an address.

27. The method in claim 1 wherein:
the owner's predetermined identification is a number.

28. The method in claim 1 wherein:
the owner's predetermined identification is comprised of symbols.

29. The method in claim 1 wherein:
the owner's predetermined identification is comprised of numbers and symbols selectively.
